(19) United States
(12) Patent Application Publication
(10) Pub. No.: US 2007/0180677 A1
(43) Pub. Date: Aug. 9, 2007

(54) Internal high-pressure shaping method for shaping conical tubes made of metal

(75) Inventors: Stefan Schwarz, Lunen (DE); Sven Franz-Josef Schneider, Boxberg-Windischbuch (DE); Matthias Aust, Slanheim (DE)

Correspondence Address: PROSKAUER ROSE LLP;PATENT DEPARTMENT, 1585 BROADWAY, NEW YORK, NY, 10036-8299, US

(73) Assignee: Thyssen Krupp Stahl AG, Duisburg (DE)

(21) Appl. No.: 10/568,265

(22) PCT Filed: Aug. 4, 2004
(86) PCT No.: PCT/EP04/08727

§ 371 Date: Aug. 18, 2006

(30) Foreign Application Priority Data
Aug. 13, 2003 (DE) 103 37 383.7

(51) Int. Cl. B23P 17/00

(52) U.S. Cl. 29/421.1

(57) ABSTRACT

The invention relates to an internal high pressure shaping method for shaping metal tubes (5) produced from metal, especially steel, in a tool (1) that has a die cavity (2) with a complex contour. Said die cavity (2) has cylindrical sections (2a, 2b) on its two opposite ends. The tube which is conical across its entire length is inserted in such a die cavity in such a manner that it lies with its ends (5a, 5b) in the area of the cylindrical sections (2a, 2b). The sealing plugs force the ends (5a, 5b) against the cylindrical sections (2a, 2b), optionally while radially flaring them, so that they come to rest clamped between the wall of the cylindrical sections (2a, 2b) and the sealing plugs. The tube (5) is forced against the complex contour of the die cavity (2) by subjecting the tube (5) to an internal high pressure and simultaneous axial compression of the tube (5).

The invention relates to an internal high-pressure shaping method for shaping conical tubes made of metal, in particular steel, in a tool comprising a die cavity having a complex contour and two sealing pistons, by means of which the interior of the tube to be shaped is sealed at its two ends, in that the sealing pistons, which engage with the tube ends, press the tube ends against the wall of cylindrical portions at the two ends of the die cavity.

In the internal high-pressure shaping of tubes, relatively high degrees of shaping may be achieved if material is axially redisplaced during radial flaring of the tubes. In the case of cylindrical tubes, the axial redisplacement of material is unproblematic. In the case of conical tubes, on the other hand, the redisplacement is not easily possible for geometrical reasons, because there are sealing problems at the conical tube ends. In order nevertheless to allow even conical tubes to undergo internal high-pressure shaping with the axial redisplacement of material, tubes are used in which short cylindrical portions are connected to the conical part. The tool accordingly comprises correspondingly cylindrical portions on both open sides of the die cavity, so the cylindrical portions of the tube to undergo internal high-pressure shaping may be clamped in a sealing manner between the cylindrical portions of the tool and the sealing piston, which is introduced into the cylindrical portions. A drawback of this is that the starting tubes necessitate substantially higher costs, owing to the different portions (cylindrical/conical/cylindrical) in the manufacturing process, than purely conical tubes. In addition, the cylindrical end portions of a tube that has undergone internal high-pressure shaping are often undesirable.

The object of the invention is to provide an internal high-pressure shaping method for shaping conical tubes, which allows high degrees of shaping of complex shapes and necessitates lower costs than the described method.

In the case of a method of the type mentioned at the outset, this object is achieved in that a tube, which is conical over its entire length and the ends of which protrude into the region of the cylindrical portions of the tool, is inserted into the tool, in that these conical ends of the tube are pressed by the sealing pistons to be introduced until they abut the cylindrical portions of the tool, optionally with radial flaring, and in that the internal high-pressure shaping process then takes place by means of internal pressure built up in the interior thus sealed of the tube, with simultaneous axial compression of the tube by means of at least one sealing piston acting on the end face of the associated tube end.

In the case of the method according to the invention, the purely conical tube that is to undergo internal high-pressure shaping is introduced into a tool of conventional configuration, wherein the unique feature consists in the fact that the conical tube ends protrude into the cylindrical end portions of the tool. Prior to the internal high-pressure shaping process itself, the conical ends are pressed by means of the sealing pistons to be introduced, in particular with radial flaring of the smaller conical end, against the cylindrical end portions in order to achieve the degree of tightness, at the tube ends with respect to the introduced sealing pistons, required for the internal high-pressure shaping process. Axial redisplacement, even up to the end of the cylindrical end portions of the tool, is nevertheless possible. An extremely flared hollow profile member of complex shape, which may be conical up to its edges, may therefore be obtained.

The invention will be described below in greater detail with reference to the drawings, in which:

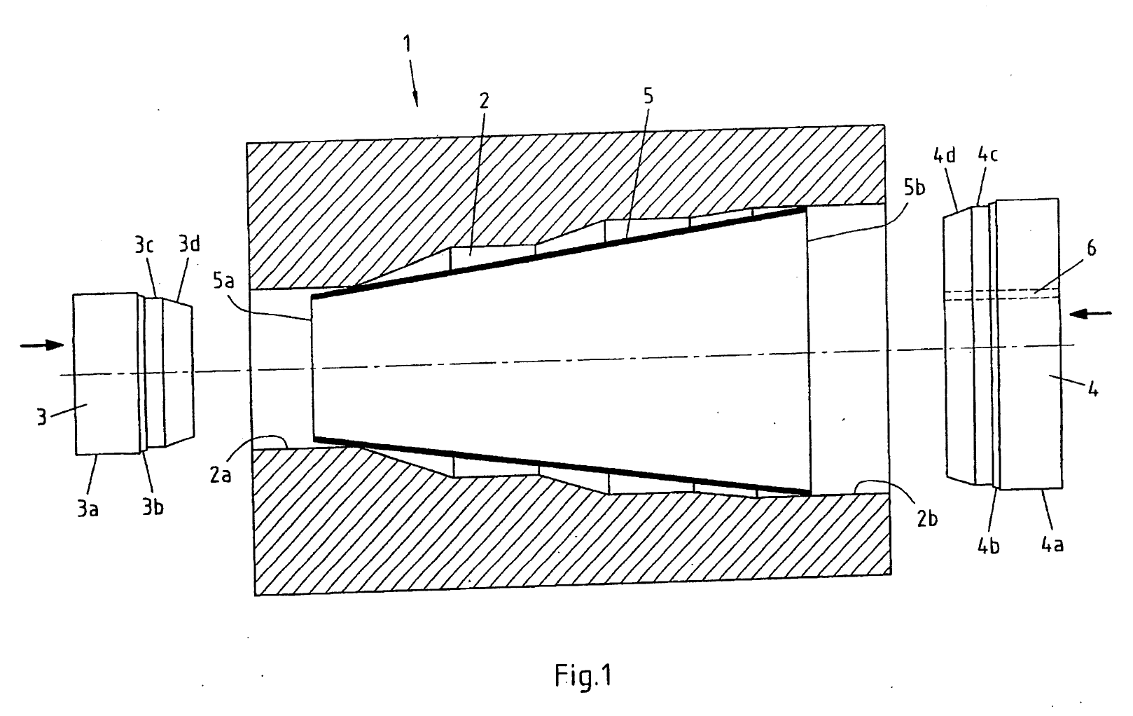

FIG. 1 is a side view and schematic cross section of a conical tube inserted into a tool, with two sealing pistons to be introduced;

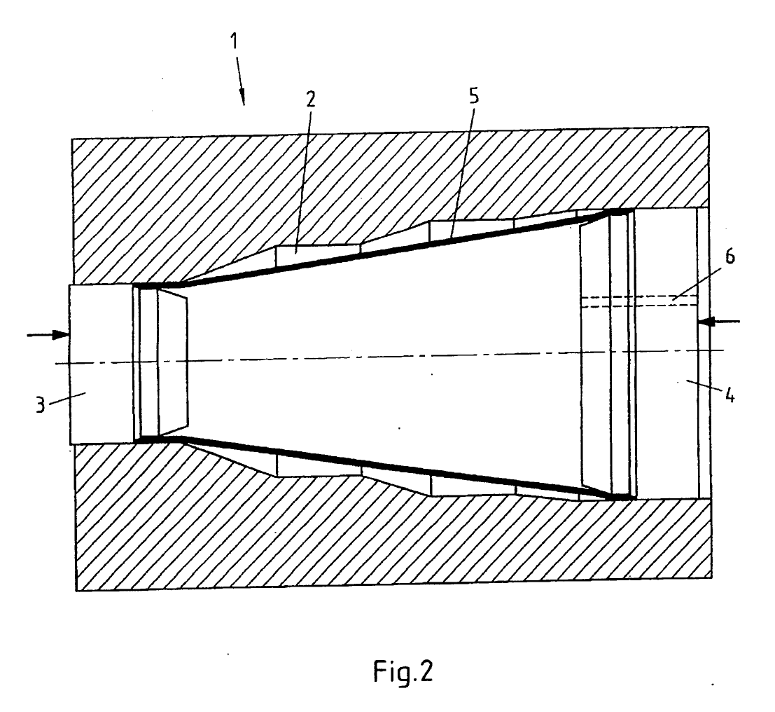

FIG. 2 shows the cylindrical tube in the tool with sealing pistons introduced into the tube ends, immediately prior to the internal high-pressure shaping process; and

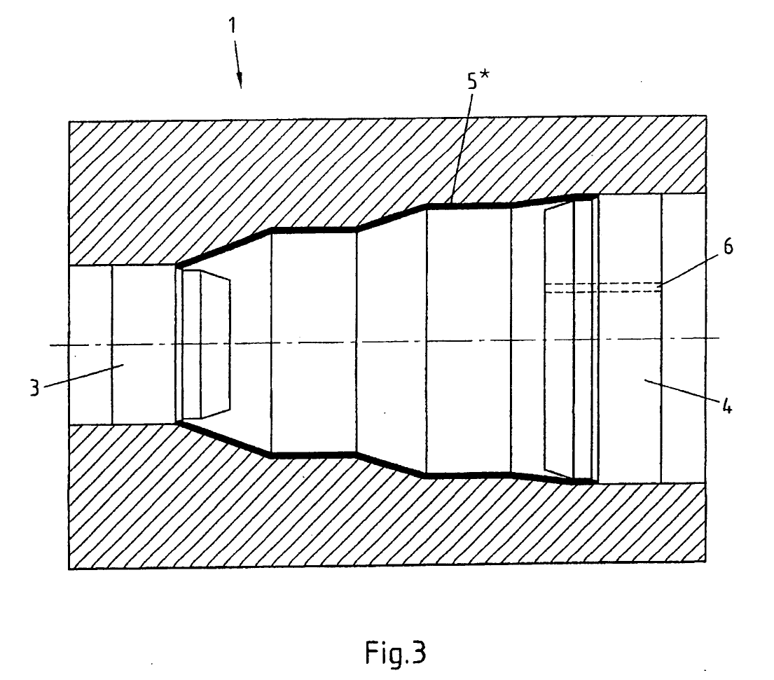

FIG. 3 shows the tube having undergone internal high-pressure shaping, at the end of the internal high-pressure shaping process.

The tool 1 comprises a die cavity 2, which is complex in shape and is composed, in the embodiment, of conical and cylindrical portions. The die cavity 2 comprises at its two open ends cylindrical portions 2a, 2b. The dimensions of two sealing pistons 3, 4 are adapted to these cylindrical portions 2a, 2b. Each sealing piston 3, 4 is divided into four portions. The portion 3a, 4a having the largest diameter corresponds to the internal diameter of the cylindrical portions 2a, 2b of the workpiece 1. The portion 3b, 4b, which is comparatively very short in the axial direction and is connected to said portion 3a, 4a having the largest diameter, is conical. A slightly longer cylindrical portion 3c, 4c, the external diameter of which is slightly smaller (=double wall thickness of the tube) than the internal diameter of the portions 2a, 2b, is connected to said conical portion 3b, 4b. Finally, a larger conical portion 3d, 4d, which acts as a mandrel for radially flaring or for centering the associated tube end, is connected to said cylindrical portion 3c, 4c.

A tube 5, which is conical over its entire length and both ends 5a, 5b of which are located within the conical portions 2a, 2b of the tool 1, is inserted into the tool 1.

If the two sealing pistons are moved from the position illustrated in FIG. 1 into the position illustrated in FIG. 2, the tube 5 is then radially flared at least at its smaller end 5a, but preferably at both its ends 5a, 5b, by means of the conical portions 3d, 4d until its edges are located between the cylindrical portions 3c, 4c and the cylindrical portion 2a, 2b of the tool 1. The configuration is such that the tube ends are clamped. As a result of the axial pressure exerted by the sealing pistons 3, 4 onto the tube 5, the edges of said tube are placed against the short conical portions 3b, 4b, thus further improving the sealing effect. Alternatively, wedge-shaped grooves, clamping sealing pistons or the like may also be provided to improve the sealing effect. The tube 5 in the tool 1 is thus prepared for the internal high-pressure shaping process.

As FIG. 3 illustrates, a pressure medium is then introduced in a manner known per se, for example via a channel 6 in the larger sealing piston 4, into the sealed interior 5c of the tube 5 and an internal high pressure is built up. This internal high pressure causes the tube 5 to flare. At the same time as the tube 5 is flared, it is also axially compressed by means of displacement of the two sealing pistons 3, 4. As a result of this axial compression, high degrees of flaring may be achieved without undesirable material thinning taking place. As FIG. 3 further illustrates, the axial displacement takes place up to the edge of the die cavity 2. A substantially deformed tube 5* having a complex structure is obtained as a result.

1. Internal high-pressure shaping method for shaping conical tubes made of metal. in particular steel. in a tool comprising a die cavity having a complex contour and two sealing pistons, by means of which the interior of the tube to be shaped is sealed at its two ends, in that the sealing pistons, which engage with the tube ends, press the tube ends against the wall of cylindrical portions at the two ends of the die cavity, characterised in that a tube, which is conical over its entire length and the ends of which protrude into the region of the cylindrical portions of the tool, is inserted into the tool. in that these conical ends of the tube are pressed by the sealing pistons to be introduced until they abut the portions, and in that the internal high-pressure shaping process then takes place by means of internal high pressure built up in the interior thus sealed of the tube, with simultaneous axial compression of the tube by means of at least one sealing piston acting on the end face of the associated tube end, wherein during the compression process at least on of the cylindrically flared tube ends is displaced up to the end of the associated cylindrical portion.

2. Method according to claim 1, characterised in that during the compression process at least one of the cylindrically flared tube ends is displaced up to the end of the associated cylindrical portion.
